(19) United States
(12) Patent Application Publication
(10) Pub. No.: US 2013/0178360 A1
(43) Pub. Date: Jul. 11, 2013

(54) NICKEL-BASED ELECTROCATALYTIC PHOTOELECTRODES

(71) Applicant: California Institute of Technology, Pasadena, CA (US)

(72) Inventors: Nathan S. Lewis, La Canada, CA (US); James R. McKone, Pasadena, CA (US); Harry B. Gray, Pasadena, CA (US)

(73) Assignee: California Institute of Technology, Pasadena, CA (US)

(21) Appl. No.: 13/734,088

(22) Filed: Jan. 4, 2013

Related U.S. Application Data
(60) Provisional application No. 61/583,696, filed on Jan. 6, 2012.

(51) Int. Cl. H01M 4/90; H01M 4/88

(52) U.S. Cl. CPC H01M 4/9091; H01M 4/9041; H01M 4/8825
USPC 502/315; 502/300

(57) ABSTRACT

The disclosure provides methods and compositions comprising metal alloy powders. The disclosure also provides a photoelectrode, methods of making and using, including systems for water-splitting are provided. The photoelectrode can be a semiconductive material having a photocatalyst such as nickel or nickel-molybdenum coated on the material.

### CROSS REFERENCE TO RELATED APPLICATIONS

This application claims priority to U.S. Provisional Application Ser. No. 61/583,696, filed Jan. 6, 2012, the disclosure of which is incorporated herein by reference.

### STATEMENT REGARDING FEDERALLY SPONSORED RESEARCH

This invention was made with government support under Grant Nos. CHE-0802907 and CHE-0947829 awarded by the National Science Foundation. The Government has certain rights in the invention.

### TECHNICAL FIELD

This invention relates to compositions and metal alloy composites and methods for making and using such composites.

### BACKGROUND

The global energy challenge is universal, and a transfer to alternative sustainable energy sources, in particular the sun, is inevitable. Improvements in existing photovoltaics, watersplitting and catalysts are important to increase energy generation.

Earth-abundant metals are attractive alternatives to the noble metal composite catalysts that are used in water electrolyzers based on proton-exchange membrane technology. Ni—Mo alloys have been previously developed for the hydrogen evolution reaction (HER), but synthesis methods to date have been limited to formation of catalyst coatings directly on a substrate.

### SUMMARY

The disclosure provides a method for generating unsupported nanopowders of nickel-molybdenum composite (Ni—Mo), which can be suspended in common solvents and cast onto arbitrary substrates. The mass-specific catalytic activity under alkaline conditions approaches that of the most active reported non-noble HER catalysts, and the coatings display good stability under alkaline conditions. The estimated turnover frequencies per surface atom at various overpotentials demonstrates that activity enhancement for Ni—Mo over pure nickel is due to a combination of increased surface area and increased fundamental catalytic activity.

The disclosure demonstrates that unsupported nanopowders of metal alloy (e.g., Ni—Mo) can be readily prepared and processed into films that have various mass loadings. The disclosure demonstrates that unsupported nanopowders of Ni—Mo can be readily prepared and processed into films that have various mass loadings, the resulting non-noble electrocatalysts exhibit high mass-specific activities for the HER under alkaline conditions. The coatings are very stable under hydrogen evolution conditions in alkaline electrolyte, but degrade after operation for a few hours under acidic conditions. The exceptionally high activity is due in part to high porosity in the films, but Ni—Mo nanopowders also exhibit enhanced per-surface-atom activity as compared with Ni, as corroborated by electrochemical polarization measurements on well-defined samples of metallurgical alloys.

The disclosure provides a method of producing a nano- or micro-particle mixed metal composite, comprising precipitating a mixed metal composite from a heated solvent system, the heated solvent system produced by adding an aqueous metal salt solution to a heated solvent, such as a polyol or water; and reducing the mixed metal composite using a reducing agent, wherein the metal salt solution is comprised of at least two transition metal containing salts, wherein the solvent system is heated at temperatures of at least 90° C., and wherein the nanoparticle mixed metal composite is comprised of oxidized metal species. In one embodiment, the process is carried out at an elevated temperature under a reducing atmosphere comprising the reducing agent. In another embodiment, the reducing atmosphere comprises at least 4% hydrogen gas and wherein hydrogen is the reducing agent. In yet another embodiment, the nanoparticle mixed metal composite precipitant is substantially purified comprising the steps of: removing the solvent from the precipitant, washing the precipitant, and drying the precipitant. The mixed metal composite is comprised of at least one, two, three, or four of the following transition metals: nickel, molybdenum, iron, cobalt, nickel, manganese, tungsten, and vanadium. In one embodiment, the mixed metal composite is comprised of at least two of the following transition metals: nickel, molybdenum, iron, cobalt, manganese, tungsten and vanadium. In yet a further embodiment, the nanoparticle mixed metal composite is comprised of nickel and molybdenum. In yet another embodiment, the mixed metal composite is comprised of at least 0.01% to 60% molybdenum. In yet another embodiment, the aqueous metal salt solution comprises an alkaline aqueous solution comprising nickel nitrate hexahydrate and ammonium molybdate. In another embodiment, the mixed metal composite is catalytically active so that it can be used in one or more catalytic conversion processes. In yet a further embodiment, the one or more catalytic conversion processes is selected from the group consisting of hydrogenation, hydrodesulfurization, and electrocatalytic hydrogen evolution. In one embodiment, the mixed metal composite has a substantially powder like consistency.

The disclosure also provides a method of making an electrode. The method comprising preparing an ink solution comprising the mixed metal composite and applying onto the electrode. In one embodiment, the electrode is formed by a method comprising dropcasting the nanoparticle mixed metal composite onto a substrate.

### BRIEF DESCRIPTION OF THE DRAWINGS

FIG. 1 shows a graph demonstrating the potential (linear) versus time (logarithmic) for a composite electrode of Ni—Mo synthesized by the methods of the disclosure and deposted onto a Ti foil. The dotted line labeled “E_{RHE}” refers to thte thermodynamic potential at which hydrogen evolution becomes favorable in this cell.

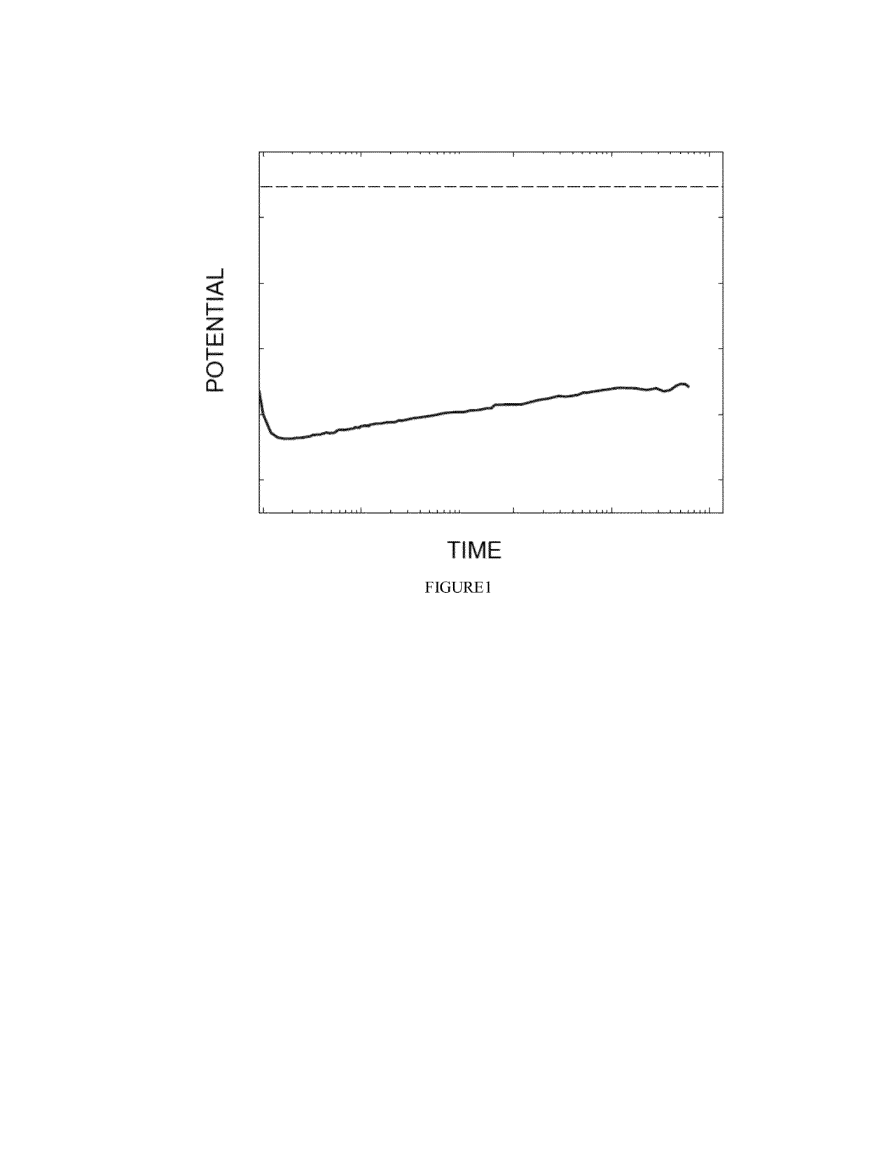

FIG. 2A-D shows scanning electron micrographs (left) and transmission electron micrographs (right) of Ni—Mo oxide intermediate (a,b) and Ni—Mo nanopowders (c,d).

FIG. 3 shows Comparison of HER catalytic activities for various electrodes in 1 M NaOH solution. Counter electrode was a Ni mesh, and the reference was Hg/HgO (1 M NaOH). Potentials are reported versus the thermodynamic potential for hydrogen evolution, which was explicitly measured after the experiments using a clean Pt electrode. Curves are labeled as follows: (a) Ti foil substrate; (b) Smooth Ni wire; (c) Ni nanopowder on Ti foil (1 mg cm⁻²); (d) Ni—Mo nanopowder on Ti foil (1 mg cm⁻²).

FIG. 4 shows Potential vs log (time) plot for Ni—Mo nanopowder films on Ti electrodes with the noted mass loadings in the noted electrolytes. Electrodes were poised galvanostatically at −20 mA cm⁻².

FIG. 5 shows current density versus mass loading (log-log plot) for Ti substrates coated with various quantities of Ni—Mo nanopowder at the noted overpotentials in 2 M KOH solution. The associated lines are fit to the data by power laws attributed to attenuation of increased catalytic activity with increased mass loading. Open and closed circles are data from two different sets of electrodes.

FIG. 6 shows room-temperature polarization data of metallurgically prepared Ni and Ni—Mo alloys with varying Mo content. Experiments were performed in 2 M KOH solution.

FIG. 7 shows a plot depicting the relationship between Ni/Mo ratio in the precursor solution (top row, above horizontal line), the resulting Ni/Mo ratio in the solid catalyst as measured by EDS (below line, x axis), and the overpotential required to pass −10 mA cm⁻² in 1 M NaOH solution using a catalyst mass loading of −0.5 mg cm⁻² (below line, y axis). Lines connect data points for a given sample before and after reaction to form the active catalyst.

### DETAILED DESCRIPTION

As used herein and in the appended claims, the singular forms “a,” “and,” and “the” include plural referents unless the context clearly dictates otherwise. Thus, for example, reference to “a composite” includes a plurality of such composites and reference to “the alloy” includes reference to one or more alloys known to those skilled in the art, and so forth.

Also, the use of “or” means “and/or” unless stated otherwise. Similarly, “comprise,” “comprises,” “comprising” “include,” “includes,” and “including” are interchangeable and not intended to be limiting.

It is to be further understood that where descriptions of various embodiments use the term “comprising,” those skilled in the art would understand that in some specific instances, an embodiment can be alternatively described using language “consisting essentially of” or “consisting of.”

By “about” is meant a quantity, level, value, number, frequency, percentage, dimension, size, amount, weight or length that varies by as much as 30, 25, 20, 25, 10, 9, 8, 7, 6, 5, 4, 3, 2 or 1% to a reference quantity, level, value, number, frequency, percentage, dimension, size, amount, weight or length.

With respect to ranges of values, the invention encompasses each intervening value between the upper and lower limits of the range to at least a tenth of the lower limit's unit, unless the context clearly indicates otherwise. Further, the invention encompasses any other stated intervening values. Moreover, the invention also encompasses ranges excluding either or both of the upper and lower limits of the range, unless specifically excluded from the stated range.

Unless defined otherwise, all technical and scientific terms used herein have the same meaning as commonly understood to one of ordinary skill in the art to which this disclosure belongs. Although methods and materials similar or equivalent to those described herein can be used in the practice of the disclosed methods and compositions, the exemplary methods, devices and materials are described herein.

The publications discussed above and throughout the text are provided solely for their disclosure prior to the filing date of the present application. Nothing herein is to be construed as an admission that the inventors are not entitled to antedate such disclosure by virtue of prior disclosure.

An approach to artificial photosynthesis involves the use of semiconductors to capture and convert sunlight into charge-separated electrons and holes. The separated charge carriers are then coupled to suitable electrocatalysts to facilitate multi-electron transfer processes that effect, at low overpotentials, the oxidation of water to O₂(g) and the reduction of water to H₂(g). Semiconductor photocathodes have shown high efficiency for production of H₂(g) from H₂O, with nearly unity internal quantum yields throughout the visible region of the solar spectrum. A globally scalable system for production of H₂(g) from sunlight and H₂O will require light absorbers and electrocatalysts that are made from more cost-effective earth-abundant materials.

Alkaline electrolysis is an attractive alternative to proton-exchange membrane (PEM)-based electrolysis because the non-noble metal electrocatalysts involved in alkaline electrolysis are stable and exhibit relatively high activity for both the hydrogen evolution reaction (HER) and the oxygen-evolution reaction (OER). Alkaline electrolyzers generally use Ni-based materials, or steel, as the electrodes and/or electro-catalysts. For example, Ni—Mo alloys exhibit high activity and long-term stability as HER catalysts under alkaline conditions. Ni—Mo composites have also recently been mixed with other elements, such as zinc or nitrogen, to provide enhanced HER activity and/or stability under neutral or acidic conditions. Electrocatalysts used in modern PEM-based fuel cell and electrolysis systems are generally synthesized as powders or colloids, and often supported on a porous, conductive matrix such as carbon black. This mode of synthesis permits facile processing and attachment of the electrocatalyst to suitable substrates, such as metallic current-collectors or ion-exchange membranes. Synthesis of highly processable powders also facilitates assessment of the maximum attainable mass-specific catalytic activity of the electrocatalyst of interest. In contrast, the electrochemical behavior of Ni—Mo alloys has generally been investigated by the synthesis of the active electrocatalyst directly onto an electrode substrate, confounding direct characterization of the morphology, composition, and activity of the electrocatalytically active species.

The disclosure provides a method for synthesizing unsupported metal catalyst composites such as Ni—Mo nanopowders that exhibit high catalytic activity for the HER. The powder is readily processed into colloidal inks.

In one embodiment, the disclosure provides methods of making nano- and micro-particulate metal composites or alloys. The metal alloys can be generated as a “powder” that then can be used for various applications including photovoltaics, water splitting and other catalytic process.

The term alloy and composite is used to describe a mixture of atoms in which the primary constituent is a metal. The primary metal is called the base, the matrix, or the solvent. The secondary constituents are often called solutes. If there is a mixture of only two types of atoms, not counting impurities, such as a nickel-molybdenum alloy, then it is called a binary alloy. If there are three types of atoms forming the mixture then it is called a ternary alloy etc. Because the percentage of each constituent can be varied, with any mixture the entire range of possible variations is called a system. In this respect, all of the various forms of an alloy containing only two constituents (e.g., molybdenum and nickel) is called a binary system, while all of the alloy combinations possible with a ternary alloy is called a ternary system, etc.

In one embodiment, the disclosure provides a two-step precipitation/reduction process to prepare metal composites (e.g., Ni—Mo nanopowders). First, an aqueous solution of a first metal salt and a second metal salt are prepared at a desired ratio. Then the mixture is heated in a solvent, such as water or a polyol solvent, leading to precipitation of a mixed metal oxide powder. The oxide powder is recovered by centrifugation, dried, and subsequently reduced under forming gas. The initial precipitation can be performed with water as the solvent.

Various metals and metal combinations can be used in the methods and compositions of the disclosure. Non-limiting embodiments of compositions include binary alloys (e.g., NiMo, NiFe, NiSn, NiS, NiZn, NiP, NiW, NiCu, NiCo, NiAl, CoP, CoMo, NiTi, etc.), ternary alloys (e.g., NiMoX where X is a metal such as Fe, Cu, Zn, Co, W, Cr, Cd, V, Ti, or the like, NiCoP, NiFeP, NiFeZn, NiCoZn, NiCuFe, NiCuMo, LaNiSi, etc.), or quaternary alloys (e.g., NiCoMnAl, etc.). Each of the metals or metalloids in the composition may be present in an atomic percent between 0.001 and 99.999%, such that the total atomic percent of the metal, metalloids, and/or other elements or compounds present totals about 100%. The amount of each of the metal or metalloid component of the composition may be varied in the composition. In a particular embodiment, the catalytic material comprises or consists essentially of nickel and molybdenum.

In one embodiment, a polyol solvent can be used. The polyol solvent can be selected from the group consisting of triethylene glycol, diethylene glycol, ethylene glycol, propylene glycol, 1,2-propylene glycol, 1,3-propylene glycol, glycerol and butylene glycol.

In one embodiment, nickel hexammine and ammonium molybdate were prepared at a 6:4 mol ratio of Ni to Mo. Then the mixture was rapidly heated in a diethylene glycol, leading to a precipitate of Ni—Mo metal oxide powder. The oxide powder was recovered by centrifugation and may optionally be washed as necessary with repeated centrifugation steps. The oxide powder is recovered by centrifugation, dried, and subsequently reduced under forming gas to generate a black Ni—Mo nanopowder.

Once formed, the nanopowder can be stored under inert gas or in a vacuum. The nanopowder can be used directly or may be resuspended and applied to a substrate using various known methods. For example, a solution or dispersion of the metal composites can be prepared from the nanopowder and then applied to the substrate by, for example, spin-coating, spray-coating, dip-coating, drop-casting or printing, for example inkjet printing, flexographic printing or gravure printing.

Heating of the metal salt mixture in the polyol solvent can be carried out at temperatures between about 50° C. to about 170° C. Centrifugation is carried out at a “g”-force sufficient to pellet the precipitate and is usually performed at room temperature or above room temperature (e.g., about 37° C. to about 115° C.). As mentioned previously, the pelleted precipitate can be washed to remove impurities. Washing is can be performed with deionized water. Typically the pellet is loosened (e.g., by sonication), resuspended and repelleted.

The solid pellet can be heated under forming gas (e.g., H₂, N₂) to dry the pellet and then stored under forming gas until ready to use. Typically the pellet is wetted with isopropanol before use to prevent pyrophoric re-oxidation. The pellet can be disrupted to a fine nano- or micro-particulate suspension (e.g., an “ink”) that can then be used to coat, drop case etc.

Using the methods above, the disclosure demonstrates the production of Ni—Mo composites that have useful and beneficial properties. However, it will be apparent the various combinations of binary, ternary and quaternary metal composites can be similarly produced.

The resulting metal composites/alloys can be used in various catalytic systems. For example, as described below the metal composites can be coated on semiconducting wires to provide catalytic systems for water systems. Similarly, the metallic nanopowder composites can be deposited either directly or after resuspension on membranes to provide catalytic membrane systems. Such membrane systems can be used in fuel cells. The catalyst active nanopowder composites, for instance, of a nickel-molybdenum (NiMo) catalyst, cobalt-molybdenum (CoMo) catalyst, platinum-alloy catalyst, metal-oxide catalyst (WO₂, MoO₃, or V₂O₅) catalysts. The nanopowder can be directly applied or applied as an “ink” to a support made, for instance, of alumina, titania, silica, carbon black or various other metallic materials or polymeric materials.

In one embodiment, the disclosure provides Ni—Mo powders that can be deposited on a substrate to serve as electrocatalyst. In certain embodiments, the substrate is a silicon-based substrate.

Ni and Ni—Mo are known electrocatalysts for H₂(g) production, and in smooth forms (γ≈1) have exhibited exchange current densities between 10⁻⁶ and 10⁻⁴ A cm⁻² in acidic electrolyte, compared to 10⁻³ A cm⁻² for Pt. Although Ni or Ni—Mo may be inferior at high current densities compared to Pt, e.g., in proton-exchange membrane (PEM) based electrolyzers, which must minimize the area-related capital expenses associated with the membrane-electrode assembly and the balance of systems in such devices, such electrocatalysts are viable alternatives to Pt, when deposited onto Si nano- or micro-wire array photocathode surfaces.

Within this description, the term “semiconductor” or “semiconducting substrate” and the like is generally used to refer to elements, structures, or devices, etc. comprising materials that have semiconductive properties, unless otherwise indicated. Such materials include, but are not limited to: elements from Group IV of the periodic table: materials including elements from Group IV of the period table; materials including elements from Group III and Group V of the periodic table; materials including elements from Group II and Group VI of the periodic table; materials including elements from Group I and Group VII of the periodic table; materials including elements from Group IV and Group VI of the periodic table; materials including elements from Group V and Group VI of the periodic table; and materials including elements from Group II and Group V of the periodic table. Other materials with semiconductive properties may include: layered semiconductors; metallic alloys; miscellaneous oxides; some organic materials, and some magnetic materials. The term “semiconducting structure” refers to a structure consisting of, at least in part, a semiconducting material. A semiconducting structure may comprise either doped or undoped material.

In one embodiment of the disclosure, the metal alloy powders of the disclosure can be used to form an “ink” which can then be used to coat wire arrays or other semiconducting structures with the metal alloy catalysts (e.g., a nickel-molybdenum photocatalyst).

A semiconducting substrate (e.g., a planar or micro- and/or nano-wire semiconducting array) can be coated with a catalyst of the disclosure. In one embodiment, a nano- or micro-powder comprising a plurality of metals is generated as above. The powder can then be directly applied to the substrate or may be resupended to an “ink” like suspension and then the substrate painted, sprayed or dipped in an “ink” electrocatalyst bath.

The following examples are meant to illustrate, not limit, the disclosed invention.

### EXAMPLES

Preparation of powders. A sample synthetic procedure for Ni—Mo nanopowder with a 6/4 ratio of Ni/Mo is shown below. Other ratios were also synthesized by keeping the total concentration of dissolved metal species roughly constant. 1.5 g (5.2 mmol) nickel nitrate hexahydrate (Aldrich 97%) and 0.6 g (3.4 mmol Mo basis) ammonium heptamolybdate (Aldrich reagent grade) were added to 5 mL deionized (Nanopure, >18 MΩ) water, to which was added 2 mL of 30% ammonium hydroxide (Macron Chemicals). After adding the ammonium hydroxide, the green solution turned a deep blue color and the molybdate salt dissolved readily. This solution was added at once to 45 mL diethylene glycol (Aldrich ReagentPlus) at room temperature. The mixture was placed in a 100 mL tall-form beaker and heated on a hotplate set to 350° C. with stirring (500 rpm) using a magnetic stir bar. When the temperature reached approximately 70° C., a green solid began to precipitate. Upon reaching −110° C., the reaction had become blue-green and completely opaque, and the remaining water in the mixture began to boil. At this time, the reaction was removed from the hotplate, allowed to cool for approximately 30 seconds, and then transferred into 4 15-mL centrifugation tubes. While still hot, the suspension was centrifuged at 3000 rpm for ˜10 minutes, after which there was approximately 1 mL-1 of green solid in each vial along with a pale blue supernatant.

For each fraction, the supernatant was discarded and the green solid was washed with 5 mL of deionized water. Thorough washing was aided by sonication using a Ti horn sonicator (Qsonica, 500W model) set to 20% power to fully re-suspend the solid. After the water wash and a second centrifugation, the green solid appeared to decrease somewhat in volume and the supernatant was very light blue. Subsequent washing with water gave colorless supernatant, so only one water wash was employed. After a subsequent washing with acetone and centrifugation, the solid was suspended a final time in a minimum of methanol and poured into a crystallization dish. The dish was heated on a hotplate set to 60° C. for several hours, yielding a pale green solid.

The green solid was transferred to a ceramic crucible and heated in a home-built tube furnace (components from Omega Engineering) under forming gas (5% H₂, 95% N₂, 500 sccm, Airliquide), first at 200° C. for 30 minutes, and then at 450° C. for 1 hour. After heating, the resulting black solid was cooled completely under forming gas and then withdrawn toward the end of the tube. Before fully withdrawing the crucible, however, a small quantity of isopropanol (Aldrich) was transferred into the crucible so as to wet the solid and prevent pyrophoric re-oxidation. Warning: if this step was not taken, on withdrawing the solid to air the crucible became hot to the touch and portions of the solid spontaneously ignited to red heat, closely resembling wood fire embers. Upon cooling, portions of the solid had turned brownish green. Allowing the solid to spontaneously react in air still yielded active catalyst material, since deposited films were subsequently reduced again before testing (vide infra). Wetting with isopropanol, however, inhibited any observable spontaneous oxidation.

The black solid was suspended in a minimum of isopropanol and ground with a mortar and pestle to homogenize large agglomerates. Then the resulting viscous suspension was transferred to a glass vial and sonicated using a bath sonicator (Branson 1210) for at least 30 minutes to yield a smooth black colloidal “ink”. The Ni—Mo ink remained well suspended for only a few minutes, but could be easily re-suspended by further sonication, vigorous shaking, or agitation in a vortex mixer.

Preparation of nanopowder-coated electrodes. For preparation of electrodes, Ni—Mo nanopowder inks as described above were prepared in mass concentrations ranging from 1-100 mg m⁻¹. Mass concentrations were verified by measuring on a microbalance the dry mass left behind by a known volume after the solvent had fully evaporated. Known quantities were then transferred by pipette to the surface of cleaned Ti foils (Alfa Aesar) that had been cut into 5-10 mm squares. Coated foils were then annealed under forming gas at 400-450° C. for 30 minutes, and cooled to room temperature under forming gas. This second reduction step was required to give high HER activity, and appeared to greatly improve the conductivity of the catalyst coating. The foils were fashioned into electrodes by contacting to a copper wire using silver paint (SPI supplies). The wire was threaded through a 6 mm diameter glass capillary and all surfaces except the active electrode area were coated with two-part epoxy (Hysol 9460).

Preparation of metallurgical samples. Metallurgically-prepared Ni—Mo alloy samples in the form of cylindrical rods, with Mo contents of 1%, 4%, and 12%, were procured from Princeton Scientific Corp. A 99.999% pure Ni rod was also procured from Alfa Aesar. The rods were cut into coin-sized samples using a slow-speed saw equipped with a low concentration boron nitride blade (Buehler). Samples were then lapped and polished, first using silicon carbide paper on a rotating wheel (South Bay Technology) and finished using diamond polishing compound (Buehler) on an automatic polishing apparatus (Buehler Minimet). Electrodes were then prepared in the same fashion as with the Ti foil substrates for the nanopowder samples.

The final polishing step made use of 50 nm diamond grit combined with a few drops of Marble's reagent (˜10 wt % CuSO₄ in 6M HCl). This chemo-mechanical polishing step led to very smooth surfaces with visible contrast in the scanning electron microscope that was attributed to polycrystalline grain boundaries. Without including etchant in the final polishing step, electrochemistry results did not yield a clear relationship between Mo content and electrochemical activity. This is possibly due to polishing damage that disrupts the surface chemical composition of metal alloys, resulting in surface composition that does not reflect the bulk alloy composition.

Electrochemical methods. All electrochemistry data were collected on a Gamry Reference 600 potentiostat, which is capable of potential control, current control, and impedance analysis. Electrolytes for hydrogen evolution experiments were either 0.5 M H₂SO₄, 1 M NaOH, or 2 M KOH solution, as noted in the main text. Polarization data were collected at slow scan rates (2-10 mV sec-1) with solution agitation by fast stirring using a magnetic stir bar, and uncompensated resistance was corrected using the current-interrupt method. Stability data were collected under galvanostatic conditions without solution agitation, and were not corrected for uncompensated resistance. Research-grade H₂(g) (Airliquide) was bubbled at 1 atm through the working compartment during all experiments, so as to ensure a well-defined thermodynamic potential for the HER. Reference electrodes for acid experiments were either saturated calomel (SCE) or mercury/mercury sulfate (MSE). Also for acid experiments, the counter electrode was a home-built Ru/Ir oxide (from pyrolysis of Ru and Ir chloride salts, Aldrich) electrode supported on Ti mesh (Alfa Aesar), contained behind a Nafion® (Fuelcellstore.com) separator. For alkaline experiments, reference electrodes were either SCE or mercury/mercury oxide (Hg/HgO) filled with 1M NaOH solution, and the counter electrode was a large area Ni mesh contained in the same compartment as the working electrode. During alkaline experiments, few bubbles were observed on the Ni counter electrode, implying that the main reaction at the counter electrode was oxidation of the Ni electrode to Ni oxide (insoluble under alkaline conditions) and/or hydrogen oxidation.

In all cases, the reversible hydrogen electrode (RHE) potential was determined explicitly in the electrolyte of interest by saturating the solution with H₂(g) at 1 atm and measuring the open-circuit potential of a freshly cleaned Pt electrode. Generally these calibration experiments were carried out after testing non-noble metal electrodes so as to avoid Pt contamination.

Microscopy and elemental analysis. Scanning electron microscopy (SEM) was performed using a Zeiss model 1550 field-emission scanning electron microscope, equipped with an Oxford X-Max SDD X-ray Energy Dispersive Spectrometer (EDS) system.

Further structural characterization was performed using an FEI Tecnai F-20 transmission electron microscope (TEM) operated at 200 kV and equipped with an EDAX energy dispersive x-ray detector and a Gatan Image Filter (GIF). For TEM analysis, a small quantity of Ni—Mo nanopowder was suspended in 90% isopropanol, 10% acetylacetone (acac, Aldrich), which increased the stability of the colloid. The suspension was drop-cast onto a lacey carbon/Cu grid. The SEM and TEM images were subjected to a minimum of post-processing, being limited to normalization of pixel intensity maxima uniformly across the image so as to produce optimal contrast.

Relationship between Mo Loading and HER Activity in Powders. A consistent relationships was observed between the relative quantity of Mo included in the initial precipitation reaction, the Mo loading subsequently observed in the catalyst powders, and the catalytic activities of the powders under alkaline conditions.

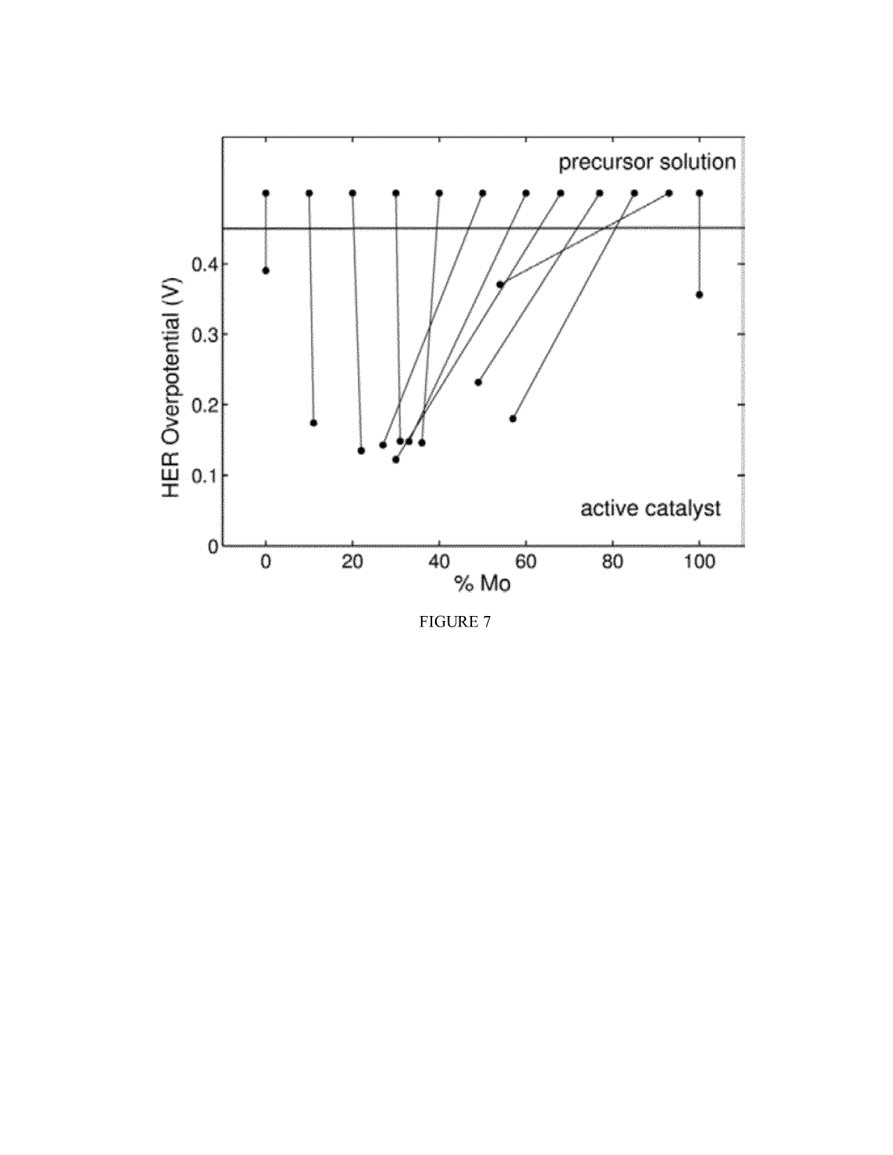

Syntheses were attempted with Mo loading ranging from 0% to 100%, but the actual Mo content in the reduced powders only ranged from 0% to ˜60% mole fraction (FIG. 7). Interestingly, an ammonium nickel molybdate reported previously by Levin, et al. exhibits varying Mo content corresponding to a formula of (NH₄)H₂xNi₃-xO(OH) (MoO₄)₂, with 0<x<1.5. Thus the upper limit of Mo content for the synthesis of this compound was 57%, in close agreement with the upper range observed in our powders. We were also able to obtain powder samples with higher Nickel content by including excess Ni relative to the stoichiometry limit implied by the aforementioned formula. When excess Mo was used for the precipitation reaction, the total yield of powder decreased to the point where a “pure Mo” synthesis yielded no precipitation at all. Instead pure Mo oxide nanopowder was procured commercially (Alfa Aesar) and reduced under the same conditions for comparison to Ni and Ni—Mo nanopowders.

Based on the factors above, the following mechanism is proposed for the generation of Ni—Mo oxide powders in the observed Ni/Mo ratios. Upon heating in diethylene glycol, Ni nitrate reacts with ammonium molybdate to give the mixed nickel molybdate as reported by Levin, et al. up to the maximum Mo content that can be incorporated into the crystal structure for solutions containing excess molybdenum. In the case where Mo is the limiting reagent, all Mo in the starting mixture is incorporated into the resulting precipitate. If Ni is in excess (e.g., Ni/Mo>1.5), some or all of the nickel nitrate precipitates as nickel hydroxide upon heating, likely due to loss of ammonia from solution, destabilizing the nickel hexammine complex. Conversely, if Mo is in excess (e.g., Ni/Mo<0.75), some Mo stays in solution as soluble molybdate or perhaps an oxo-molybdenum glycolate complex.

Catalytic activities for Ni—Mo powders under alkaline conditions correlated only weakly with Mo content (FIG. 7). For Mo loading of 0%<[Mo]<50% the activity was markedly improved over 100% Ni or 100% Mo. In particular, [Mo] values around 20-40% appeared to give maximal HER activity. This is consistent with previous results from Brown and Mahmood, who saw significant enhancement in HER activity under alkaline conditions for [Mo]>10% and no clear further increase in activity for 10%<[Mo]<40%.

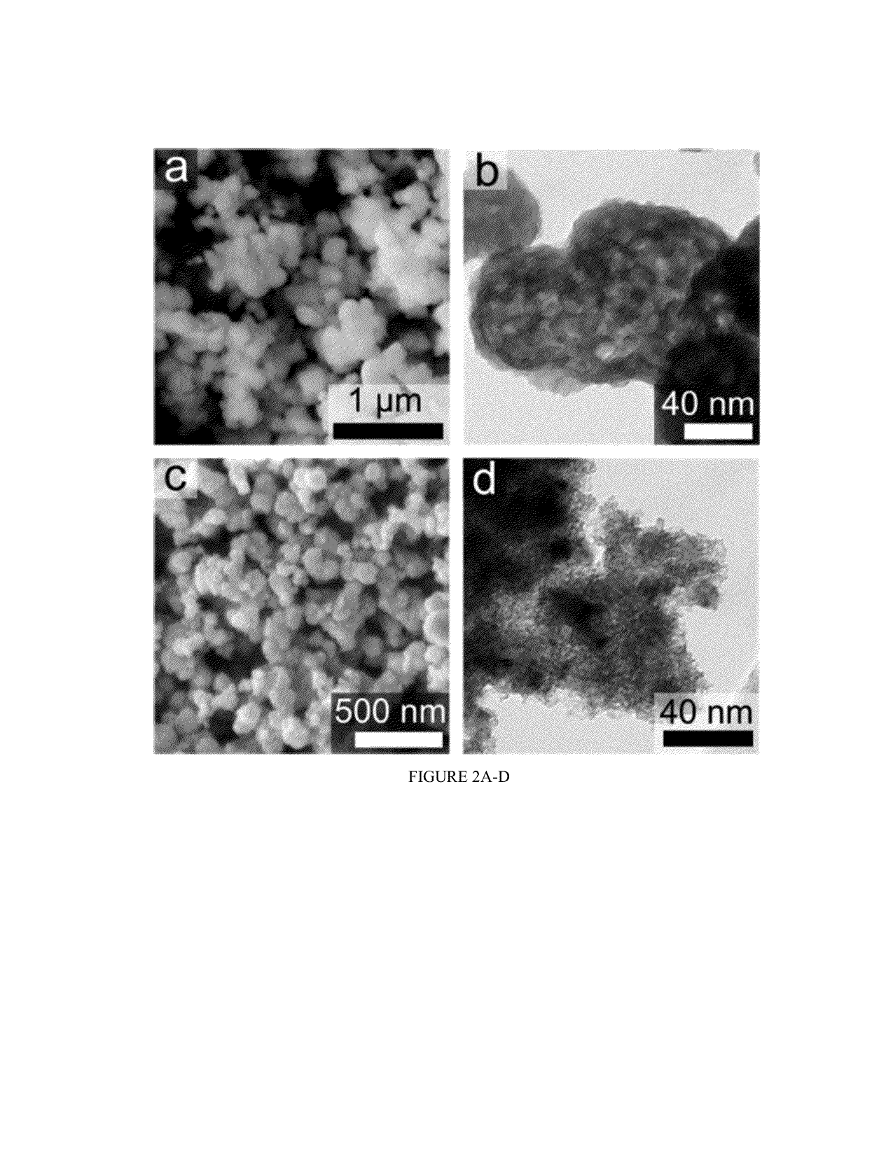

FIG. 2 shows scanning electron microscope (SEM) and transmission electron microscope (TEM) images of the Ni—Mo oxide and Ni—Mo nanopowders. The Ni—Mo oxide exhibited a polydisperse nanoparticulate morphology, with particle sizes ranging from 50 to 300 nm. The oxide also exhibited low crystallinity by electron diffraction. Upon reduction, the powder retained nano-particulate morphology, but exhibited increased crystallinity and porosity (FIG. 2d). The increase in porosity is consistent with the volume contraction expected upon reduction of the oxidized intermediate to the putatively metallic Ni—Mo product. Energy dispersive spectroscopic analysis integrated in the SEM indicated that, for powders that had 40% Mo content, the Ni:Mo atomic ratios in the powders generally were in accord with the Ni:Mo atomic ratios in the precursor solutions. For precursor solutions with >40% Mo content, however, the resulting catalyst contained a lower proportion of Mo.

The hydrogen evolution activity and electrochemical stability of these Ni—Mo nanopowders were evaluated under alkaline and acidic conditions by dispersing the Ni—Mo in isopropanol followed by deposition of the particles onto clean Ti electrodes. The highest catalytic activities were observed after a second reduction step had been performed on the deposited films, presumably because of the tendency of the nanopowders to form surface oxides in air. Indeed, the powders were pyrophoric in air, and were generally kept wet with water or solvent until catalytic films were generated.

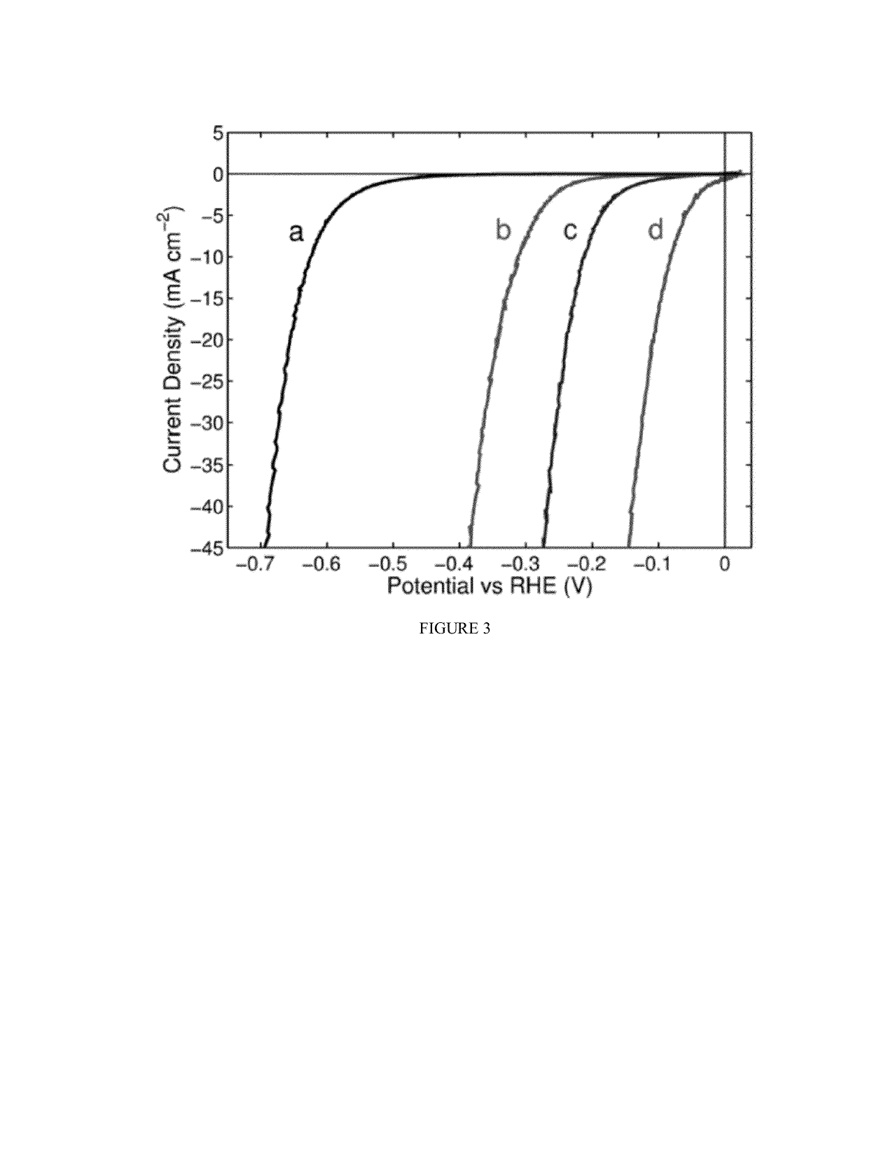

FIG. 3 shows the room temperature polarization data under alkaline conditions for various catalysts, including films of Ni—Mo nanopowders on Ti. For Ni—Mo loadings of 1 mg cm⁻², <100 mV overpotential, η, was required to sustain cathodic current densities in excess of 10 mA cm⁻². These activities greatly exceeded those exhibited by the Ti substrate, by smooth Ni electrodes, or by Ni nanopowder films that had been generated by the same precipitation-reduction. Ni—Mo films exhibited similarly high catalytic activities under alkaline conditions for Mo contents ranging from 10 to 50%.

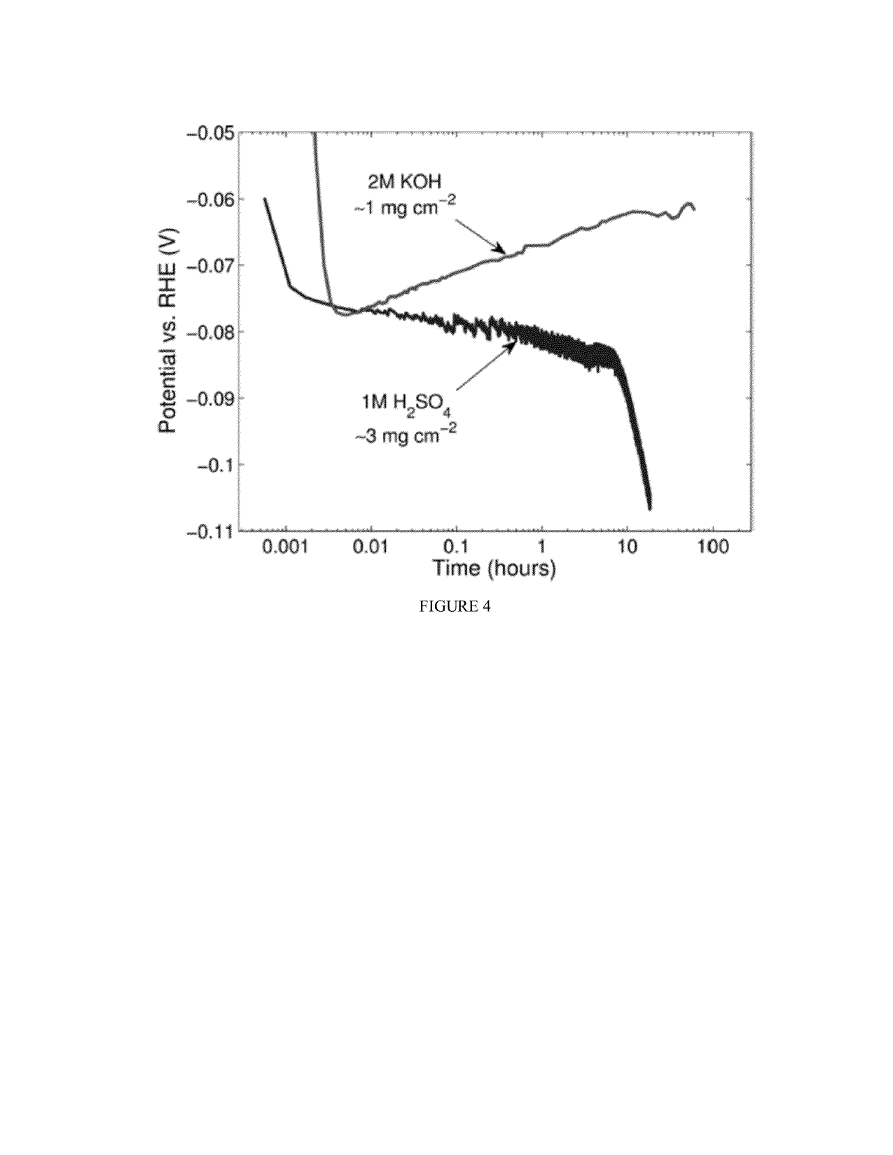

The stability of the deposited Ni—Mo electrocatyst films was evaluated under acidic and alkaline conditions by galvanotstatic control of the electrodes at a current density J=−20 mA cm⁻² (FIG. 4). Under alkaline conditions, the overpotential at J=−20 mA cm⁻² was stable for 100 h, and in fact η decreased approximately linearly with log(time) over the time period. This aging effect, which has been observed previously, was attributed to the dissolution of residual molybdenum not incorporated into an alloy phase in the electrocatalyst.

Under acidic conditions, the η required to pass −20 mA cm⁻² was also initially <100 mV. However, in acid, η increased (linearly) with log(time), and the performance degraded rapidly after ˜7 h under galvanostatic conditions. This behavior is in accord with expectations for a continuous, slow corrosion of the catalyst coating, which eventually led to dissolution of a large fraction of the electrocatalytic material. Greatly enhanced stability in acidic media has been reported recently for Ni—Mo materials mixed with carbon and nitrogen, albeit at much higher overpotentials to obtain similar J values to those reported herein. The hydrogen evolution activity data for this and several recently reported catalyst systems are compared in Table 1.

TABLE 1
Collected HER Catalysis Data

| catalyst | loading (mg cm⁻²) | electrolyte | temperature (° C.) | η (mV) | J (mA cm⁻²) | reference |
|---|---|---|---|---|---|---|
| Ni—Mo nanopowder | 1.0 | 2M KOH | 25 | 70 | 20 | this work |
| Ni—Mo nanopowder | 3.0 | 0.5M H₂SO₄ | 25 | 80 | 20 | this work |
| Ni—Mo nanopowder | 13.4 | 2M KOH | 25 | 100 | 130 | this work |
| Ni—Mo on Ni | 20 | 30 wt % KOH | 70 | 80 | 1000 | Brown and |
| | | | | | | Mahmood⁵ |
| Ni—Mo on Ni | 40 | 1M KOH | 40 | 110 | 400 | Xiao, et al.²³ |
| Ni—Mo nitride nanosheets | 0.25 | 0.1M HClO₄ | 25 | 200 | 3.5 | Chen, et al.⁶ |
| Pt on Carbon | 0.28 | 0.5M H₂SO₄ | 25 | 50 | 20 | Li, et al.²⁴ |
| amorphous MoSₓ | (10¹⁷ sites cm⁻²) | 0.5M H₂SO₄ | 25 | 200 | 10 | Benck, et al.²⁵ |
| MoS₂ on reduced graphene oxide | 0.28 | 0.5M H₂SO₄ | 25 | 150 | 10 | Li, et al.²⁴ |
| MoSₓ on graphene-coated Ni foam | 8 | 0.5M H₂SO₄ | 25 | 200 | 45 | Chang, et al.²⁶ |

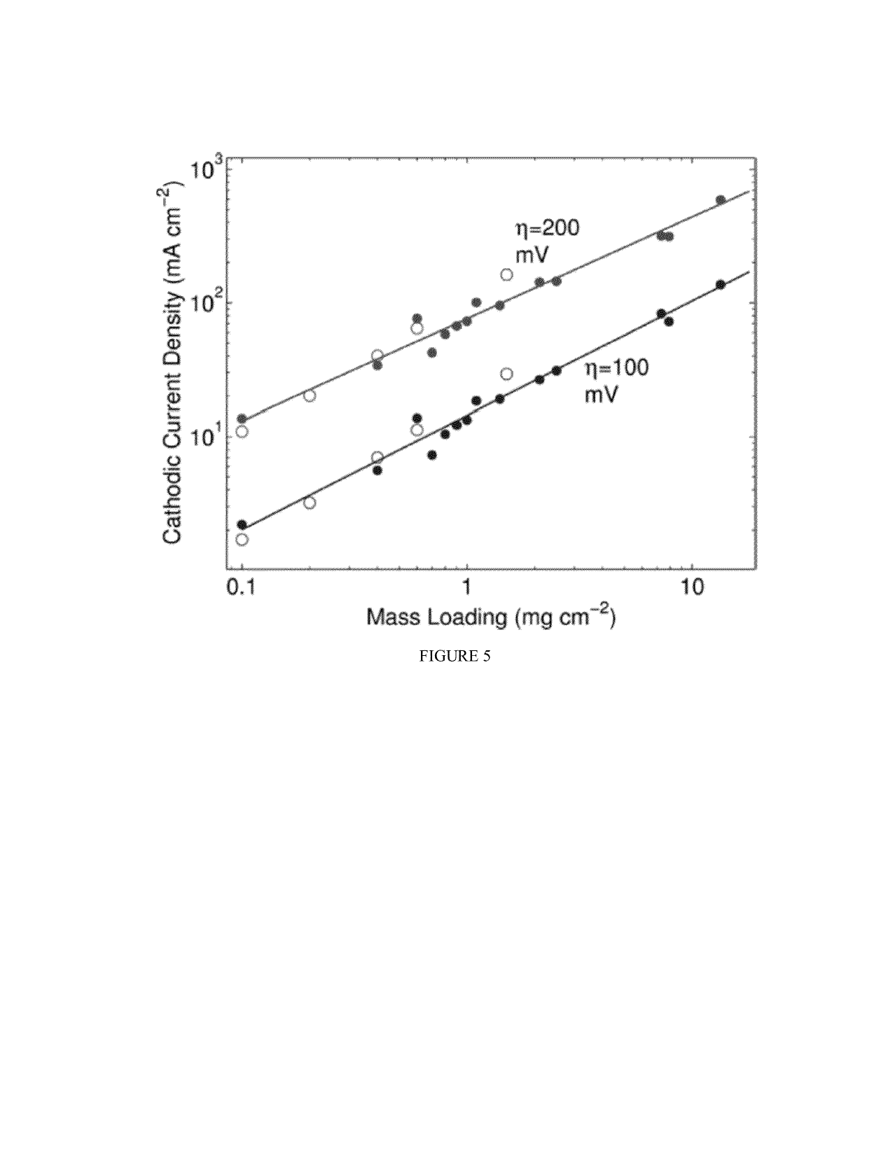

FIG. 5 shows the current densities produced at constant overpotentials of 100 and 200 mV, respectively, by various Ni—Mo loadings on Ti. The relationship between the mass loading and the current density was well described by a power law, for example, J=−14.45 m^{0.86} at η=100 mV, where J is the current density in mA cm⁻² and m is the mass loading in mg cm⁻² (bottom line in FIG. 5). The observed power law is consistent with attenuation of the marginal increase in activity with increased mass loading due to diminished transport of reactant species through porous films of increasing thickness.

For comparison, current densities J=−1000 mA cm⁻² have been observed at η=80 mV for highly optimized Ni—Mo electrodes at ˜20 mg cm² mass loading and at 70° C. in 30 wt % KOH(aq). The mesh geometry, electrolyte concentration, and increased temperature presumably all contributed to the very high observed activity for this Ni—Mo cathode. In the present system, mass loadings >10 mg cm⁻² were difficult to obtain because of poor adhesion of such nanoparticle films to the Ti substrate. The adhesion could likely be improved, however, by the use of polymer binders or mesh substrates that have similar surface redox chemistry and thermal expansion characteristics as the catalytic coating.

Measurement of mass-specific catalytic activities enables an estimation of the activity of Ni—Mo nanopowders on a per-surface-atom basis, given a series of approximations regarding particle composition and morphology. The total surface area of 0.1 mg of spherical, 5 nm diameter particles with a density of 9.5 g mol⁻¹ (based on the weighted-average density of 6:4 Ni/Mo metals) is ˜130 cm², implying that the roughness factor, γ, for a 0.1 mg cm⁻² sample is ˜130. Assuming that the nanoparticle surfaces exhibit the weighted-average lattice constants of their bulk Ni and Mo components, 0.1 mg of material contains 0.4 μmol of surface atoms. Hence for films with low mass loading, the turnover frequencies can be estimated as 0.05 s⁻¹ at η=100 mV and 0.36 s⁻¹ at η=200 mV.

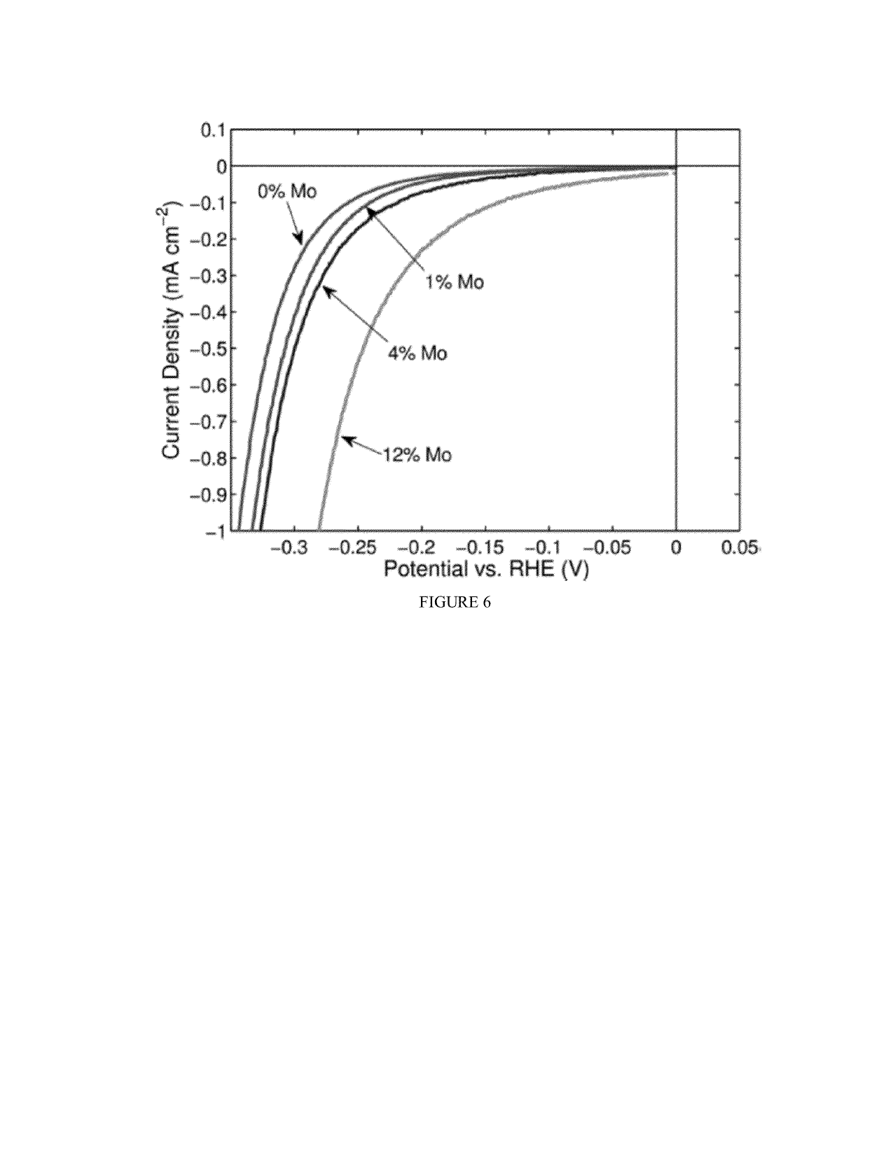

Commercially available samples of pure Ni, as well as of metallurgically prepared Ni—Mo alloys with Mo loadings of 1, 4, and 12%, respectively, were also evaluated electrochemically for their activities toward the HER. Samples of these materials were cut and polished to produce a smooth surface, chemically etched to remove surface polishing damage, and tested for electrocatalytic hydrogen evolution activity under alkaline conditions (FIG. 6). The data showed a clear monotonic trend, in which increasing Mo loading resulted in decreased overpotentials required to obtain a specified current density. Notably, assuming surface roughness factors of 1, the data for 0 and 12% Mo imply turnover frequencies at η=100 mV of 0.03 and 0.2 s⁻¹ per surface atom, respectively. These values are within an order of magnitude of those estimated for the Ni—Mo nanopowders, and support the notion that alloying Mo into Ni increases the fundamental hydrogen evolution activity of Ni metal. This further implies that both enhanced fundamental reactivity and increased surface area are operative in the observed catalytic activity of Ni—Mo nanopowder.

Although a number of embodiments and features have been described above, it will be understood by those skilled in the art that modifications and variations of the described embodiments and features may be made without departing from the teachings of the disclosure or the scope of the invention as defined by the appended claims.

What is claimed is:

1. A method of producing a nanoparticle mixed metal composite, comprising:
(a) precipitating a nanoparticle mixed metal composite from a heated solvent system, the heated solvent system produced by adding an aqueous metal salt solution to a heated solvent; and
(b) reducing the nanoparticle mixed metal composite using a reducing agent;
wherein the heterogeneous metal salt solution is comprised of at least two transition metal containing salts, wherein the solvent system is heated at temperatures of at least 90° C., and wherein the nanoparticle mixed metal composite is comprised substantially of oxidized metal species.

2. The method of claim 1, wherein (b) is carried out at an elevated temperature under a reducing atmosphere comprising the reducing agent.

3. The method of claim 2, wherein the reducing atmosphere comprises at least 4% hydrogen gas and wherein hydrogen is the reducing agent.

4. The method of claim 1, wherein prior to step (b) the nanoparticle mixed metal composite precipitant is substantially purified comprising the steps of: removing the solvent from the precipitant, washing the precipitant, and drying the precipitant.

5. The method of claim 1, wherein the nanoparticle mixed metal composite is comprised of at least one of the following transition metals: nickel, molybdenum, iron, cobalt, nickel, manganese, tungsten, and vanadium.

6. The method of claim 1, wherein the nanoparticle mixed metal composite is comprised of at least two of the following transition metals: nickel, molybdenum, iron, cobalt, nickel, manganese, tungsten and vanadium.

7. The method of claim 6, wherein the nanoparticle mixed metal composite is comprised of nickel and molybdenum.

8. The method of claim 7, wherein the nanoparticle mixed metal composite is comprised of at least 0.01% to 60% molybdenum.

9. The method of claim 1, wherein the aqueous heterogeneous metal salt solution comprises an aqueous solution comprising nickel nitrate hexahydrate and ammonium molybdate.

10. The method of claim 1, wherein the nanoparticle mixed metal composite is catalytically active so that it can be used in one or more catalytic conversion processes.

11. The method of claim 10, wherein the one or more catalytic conversion processes is selected from the group consisting of hydrogenation, hydrodesulfurization, and electrocatalytic hydrogen evolution.

12. The method of claim 1, wherein the nanoparticle mixed metal composite has a substantially powder like consistency.

13. An electrode comprising the nanoparticle mixed metal composite of claim 10.

14. The electrode of claim 13, wherein the electrode is formed by a method comprising dropcasting the nanoparticle mixed metal composite onto a substrate.
